(19) United States
(12) Patent Application Publication
(10) Pub. No.: US 2005/0011545 A1
(43) Pub. Date: Jan. 20, 2005

(54) Apparatus and a method for cleaning enclosed spaces

(76) Inventor: Hallgrimur Jonsson, Seydisfloeder (IS)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 10/498,196

(22) PCT Filed: Oct. 16, 2002
(86) PCT No.: PCT/IS02/00017

(30) Foreign Application Priority Data
Dec. 19, 2001 (IS) 6208

(51) Int. Cl. B08B 3/02

(52) U.S. Cl. 134/166 R; 134/181; 134/168 R; 134/198; 134/167 R

(57) ABSTRACT

The invention relates to an apparatus and a method to clean enclosed spaces. The apparatus consists of an inlet-pipe (1) for cleaning-medium, equipped with thread (10) on outside where a vertical displacement nut (12) is located, which moves vertically when the drive-shaft (6), which is directly connected to a cleaning-medium distributor (18) and, indirectly to a shielding-pipe (8) and nozzle-arms (15, 21), is rotated by a motor (3). The upper nozzle-arms (21) and the vertical displacement nut (12) are interconnected through vertical displacement arms (14) so that the nozzle-arms move vertically and circularly in concert with the vertical displacement nut (12) when the motor rotates the drive-shaft (6). The method relates to cleaning of various enclosed spaces with different cleaning media and is effective for cleaning enclosed spaces such as storage tanks.

### DESCRIPTION

1. Technical Field

The present invention relates to an apparatus and a method for cleaning enclosed spaces such as storage tanks and related compartments.

2. Background of the Invention

At present, there is an incresed demand for the cleanliness of storage tanks and other containers storing goods such as fuel oil, fish oil and beverages of various types e.g. beer, soda-drinks or milk. The apparatus commercially available for cleaning storage tanks place considerable requirements to the type of space to be washed and cleaned. In the case of storage tanks, the size, position of openings and the presence of columns inside the tank can limit the utility of the apparatus. In many cases, apparatus specific for certain kinds of tanks have to be constructed. In most cases the apparatus operate at high pressure thus making them expensive and bulky. Furthermore, the high pressure involved increases the the risk of explosion in the case of tanks storing explosive and/or inflammable materials.

### SUMMARY OF THE INVENTION

The aim of the present invention is to provide an inexpensive and versatile apparatus of simple construction that can be moved between spaces of different kinds and sizes. This aim is achieved by an apparatus equipped with nozzle-arms, that can be adjusted in length and move vertically upwards and downwards with the aid of specifically constructed device for displacement. The rotational movement and vertical displacement are harmonized and stepless. Detectors and switches change the displacement when the limit of vertical displacement is reached. The apparatus can also be controlled from outside, e.g. by a computer. There is no requirement for specific fastening means inside the space to be cleaned and the apparatus operates as one unit located inside the space, except for an inlet for the cleaning-medium and/or device for recycling of the cleaning-medium and optional device for controlling. The placement of openings or the presence of columns in the tank does not influence the usefulness of the apparatus. The device for vertical displacement and the means for adjusting the lenghts of nozzle-arms make it possible to exploit the force of gravity of the cleaning-medium and to operate at a lower pressure than otherwise would be possible, thus enabling the use of inexpensive nozzles and fluid-system.

As the apparatus contains no oil, it is ideal for use in the food and drink industries, where external contamination must be kept to an absolute minimum. Yet another advantage is, that only one operator is required who, if needed, can control several units at a time.

The embodiments of the invention are as characterized in the claims.

### BRIEF DESCRIPTION OF THE FIGURES

The invention is further described with references to the following figures:

FIG. 1 Side-view of the apparatus (nozzle-arms in ca. 60° position)

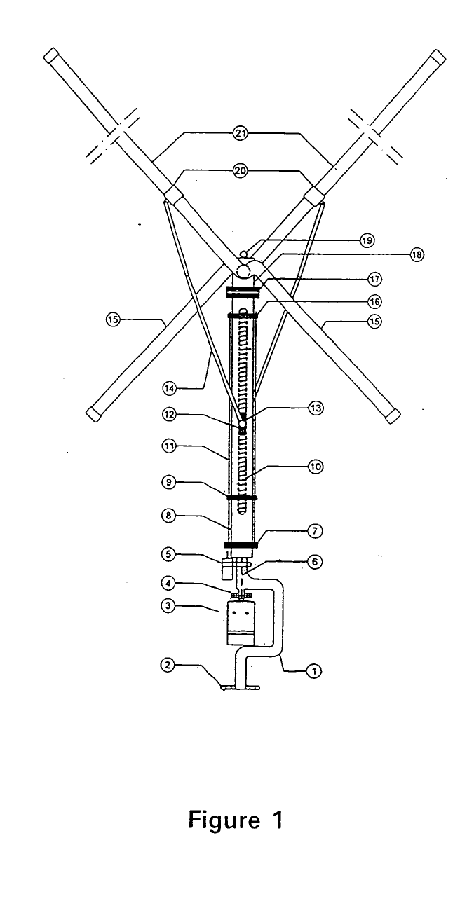

FIG. 2 Side-view of the apparatus (nozzle-arms in horizontal position)

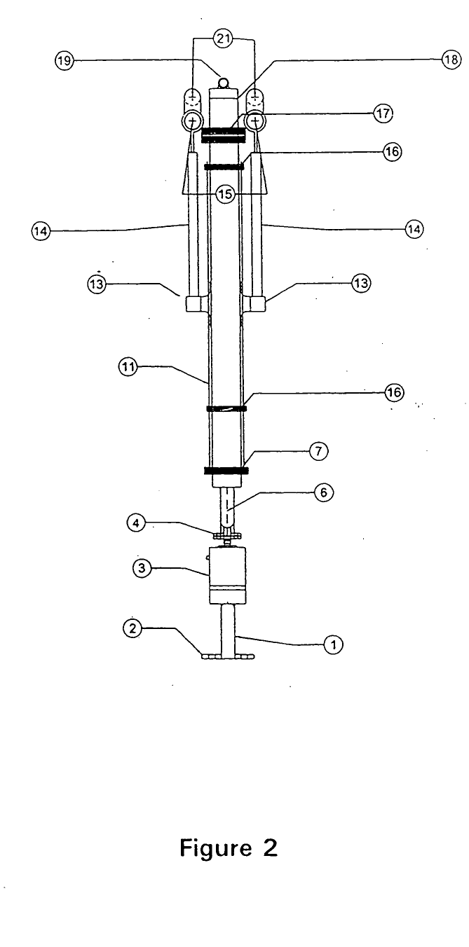

FIG. 3 Shows the apparatus from above (nozzle-arms in horizontal position)

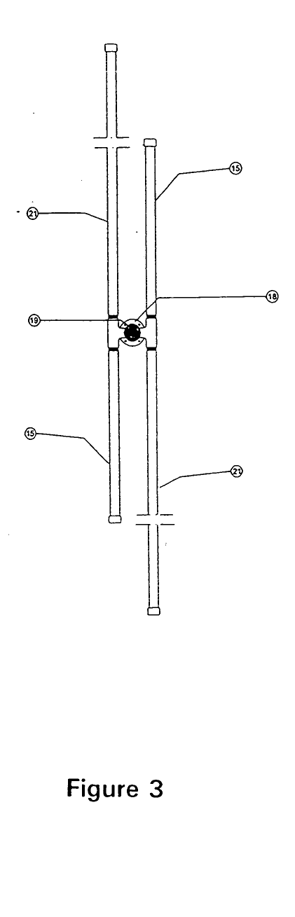

FIG. 4 Shows three dimensional view of an embodiment with two nozzle-arms (arms not shown in full length)

### DETAILED DESCRIPTION OF THE INVENTION

At the lower part of the apparatus is an inlet-pipe (1) where the cleaning-medium is let in. At the upper part, the inlet-pipe is equipped with a thread (10) with a vertical displacement nut (12). Around the inlet-pipe, mainly in the part equipped with the thread, is a shielding-pipe (8), connected to a cleaning-medium distributor ( 18) through sealing-contactor (17) but the distributor (18) is connected to the nozzle-arms (15, 21) which are adjustable in length. The upper arms (21) and lower arms (15) are one unit; a pipe that transports the cleaning-medium to the nozzles at each end from movable fastening to the distributor located approximately at the middle of the pipe. The vertical displacement arms (14) are connected at one end to the upper arms (21) with clips (20) and at the other end, through slits (22) in the shielding-pipe (8), to fastening-bolts (13) on the vertical displacement nut (12) that sits around the thread (10) on the inlet-pipe. The clips (20) can be moved on the nozzle-arms (21) and the length of the vertical displacement arms (14) can be altered. Inside the inlet-pipe (1), in the upper part, is the drive-shaft (6) that is connected at the lower end to the motor (3) through connecting-flange (4) and at the upper end to the distributor (18) and, indirectly, to the shielding-pipe (8) and nozzle-arms (15, 21). Detectors/stop-rings (9,16) are placed around the shielding-pipe (8) which are interconnected and connected to a contacting-ring (7) with pins (11). The contacting-ring (7) activates/deactivates switch (5) that in turn controls the motor (3). A swivel (19) is intended to fasten (hang up) the apparatus to the enclosed space that is to be cleaned. Similar purpose has the fastening-flange (2) at the lower end of the inlet-pipe that can be placed on a stand on the bottom of the enclosed space or can be fastened in other way.

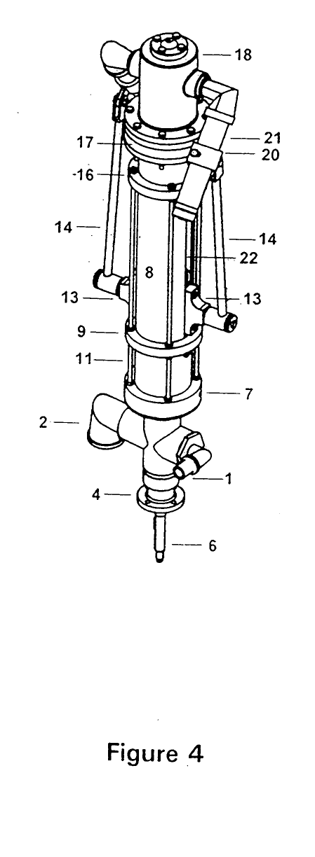

It is possible to limit the embodiment to two nozzle-arms i.e. to the upper arms (21), as shown in FIG. 4, or even to a pair (15, 21).

When in use, according to the method of the invention, cleaning-medium is led into the inlet-pipe (1) that flows into the continuation of the inlet-pipe (10) into, the distributor (18) and then all the way to the nozzle-arms (15 ,21) and the nozzles. When the motor (3) is turned on, the drive-shaft (6) rotates as well as the shielding-pipe/distributor (8/18) together with the nozzle-arms (15, 21). The rotation results in movement of the vertical displacement nut (12) either upwards or downwards, depending on the direction of rotation of the motor (3). The nozzle-arms (15, 21) move similarily either upwards or downwards in a circular movement. The vertical movement is limited by detectors/stop-rings (9,16) because when the vertical displacement nut (12) contacts the rings (9,16) a signal is transmitted to the contacting-ring (7) that in turn transmits a signal to the switch (5) which changes the rotation of the motor (3). It is possible to vary the vertical displacement and the rate of the displacement by altering the distance between the rings (9,16) and/or the position of the clips (20) on the upper nozzle-arm (21), hence the angle between the vertical displacement-arms (14) and the shielding-pipe (8). Optionally, the direction of rotation and the number of rotations can be controlled from outside of the space e. g. by a computer. The method allows exact control of nozzles and every part of the space will be cleaned in detail.

Although the apparatus was originally constructed for cleaning storage tanks of different kinds, it is also suitable for cleaning other types of spaces such as containers, ships holds or pipes. In addition, it is also ideal for use when spraying tanks with protective agents such as anti-oxidants and anticorrosives.

The cleaning-medium can be of different kinds; fluid or gas and even sand. By recycling, the activity of the cleaning-medium can be utilized to the utmost. Also, the cleaning-medium can optionally be refined e. g. outside the enclosed space to be cleaned. Furthermore, the temperature and the pressure of the cleaning-medium can be controlled.

Reference Numbers used in the Figures.

1 Inlet-pipe
2. Fastening-flange
3. Motor
4. Connecting-flange
5. Switch
6. Drive shaft
7. Contacting-ring
8. Shielding-pipe
9. Stop-ring
10. Thread
11. Pin
12. Vertical displacement nut
13. Fastening-bolt
14. Vertical displacement arms
15. Lower nozzle-arms
16. Stop-ring
17. Sealing-contactor
18. Distributor
19. Swivel
20. Clip
21. Upper nozzle-arms
22. Slit

1. An apparatus for cleaning enclosed spaces comprising nozzle-arms and a device to turn them in circular motion and, at the same time, displace them vertically upwards or downwards and a system for transporting cleaning-medium characterized by an inlet-pipe (1) for cleaning-medium, equipped with thread (10) on the outside where a vertical displacement nut (12) is located, which moves vertically when the drive-shaft (6), which is directly connected to a cleaning-medium distributor (18) through the inlet-pipe (1) and, indirectly to a shielding pipe (8) and nozzle-arms (15, 21), is rotated by a controlled motor (3) and where upper nozzle-arms (21) and said vertical displacement nut (12) are interconnected through vertical displacement arms (14) so that the nozzle-arms move vertically and circularly in concert with the vertical displacement nut (12) when the motor (3 rotates the drive-shaft (6).

2. The apparatus according to claim 1 characterized in that the motor (3) is an electric, pneumatic or hydraulic motor.

3. The apparatus according to claims 1 or 2 characterized in that a control device is built-in and consists of devices (9, 16) that detect the vertical displacement of the vertical displacement nut (12) and transmit the signal to a switching device (5) that controls the motor (3).

4. The apparatus according to claims 1 or 2 characterized in that the rotation of the motor (3) is controlled from the outside of the enclosed space.

5. The apparatus according to claims 1 or 2 characterized in that the vertical displacement arms (14) are adjustable in length.

6. The apparatus according to claims 1 or 2 characterized in that the nozzle-arms (15, 21) are adjustable in length.

7. The apparatus according to claim 1 characterized in that the nozzle-arms (21) are limited to those parts connected to the vertical displacement arms (14).

8. A method to clean enclosed spaces characterized by
a) locating in the enclosed space an apparatus comprising an inlet-pipe (1) for cleaning-medium, equipped with thread (10) on the outside where a vertical displacement nut (12) is located, which moves vertically when the drive-shaft (6), which is directly connected to a cleaning-medium distributor (18) through the inlet-pipe (1) and, indirectly to a shielding-pipe (8) and nozzle-arms (15, 21), is rotated by a controlled motor (3) and where upper nozzle-arms (21) and said vertical displacement nut (12) are interconnected through vertical displacement arms (14) so that the nozzle-arms move vertically and circularly in concert with the vertical displacement nut (12) when the motor (3) rotates the drive-shaft (6);
b) letting the cleaning-medium into the inlet-pipe; and
c) turning on the motor.

9. The method according to claim 8 characterized in that the enclosed space is a storage tank.

10. The method according to claim 8 characterized in that the enclosed space is a container, ships hold or pipe/tube.

11. The method according to claims 8, 9 or 10 characterized in that the cleaning-medium is hot or cold fluid optionally mixed with agent(s) for aiding the cleaning action.

12. The method according to claims 8, 9 or 10 characterized in that the cleaning-medium is air or sand.

13. The method according to claim 11 characterized in that the cleaning fluid is water mixed with caustic soda.

14. The method according to claim 11 characterized in that the cleaning fluid is delivered at the temperature of about 60° C. to about 90° C.

15. The method according to claim 11 characterized in that the cleaning fluid is recycled and, optionally, cleaned.

16. The method according to claim 11 characterized in that the cleaning fluid is delivered at the pressure of about 15 bars to about 20 bars.

17. The method according to claim 8 characterized in that the apparatus is placed upside-down in the enclosed space.
